(19) United States
(12) Patent Application Publication
(10) Pub. No.: US 2015/0044407 A1
(43) Pub. Date: Feb. 12, 2015

(54) COMPOSITE VESSELS

(71) Applicant: Dow Global Technologies LLC, Midland, MI (US)

(72) Inventors: Abhijit Som, Pune (IN); Vikrant V. Agrawal, Pune (IN); Hiren Patel, Navi Mumbai (IN); Saurabh Kaujalgikar, Pune (IN); Lakshmi Narasimha Vutukuru, Bangalore (IN)

(73) Assignee: Dow Global Technologies LLC, Midland, MI (US)

(21) Appl. No.: 14/385,836

(22) PCT Filed: Apr. 3, 2013
(86) PCT No.: PCT/US13/35104

§ 371 Date: Sep. 17, 2014

(30) Foreign Application Priority Data
Apr. 17, 2012 (IN) 1532/CHE/2012

(51) Int. Cl. C09D 133/02; B32B 1/02

(52) U.S. Cl. CPC C09D 133/02; B32B 1/02; B32B 2250/02; B32B 2255/10; B32B 2255/26; B32B 2307/7242; B32B 2323/043; B32B 2439/40
USPC 428/36.7; 428/447; 428/36.6; 156/242; 427/595; 427/536; 522/153; 522/77

(57) ABSTRACT

A barrier liner for a composite vessel, the barrier liner including (A) a polymeric substrate; and (B) a gas barrier coating layer attached to at least a portion of the polymeric substrate; a composite vessel containing the above barrier liner; and a UV curable composition for producing the above barrier liner.

### FIELD

The present invention is related to composite vessels; and more specifically, the present invention is related to composite vessels having a hydrocarbon barrier layer.

### BACKGROUND

Typically, composite vessels (for example cylinders, spheres or other shapes and configurations of such vessels) are designed to carry various fluids including for example liquid petroleum gas (LPG); compressed natural gas (CNG); or light hydrocarbons such as methane, propane, and butane.

Known composite vessels are usually constructed to include a combination of a composite shell and a high density polyethylene (HDPE) liner. For example, known LPG vessels are generally fabricated by forming a composite shell using a filament winding process over a HDPE liner, whereby the HDPE liner is previously manufactured for example by a blow molding process.

Since HDPE is permeable to LPG, the known composite vessel designs exhibit a high rate of LPG leakage such that the leak rate of the composite vessel can be between 0.5 grams per day (g/day) to 1 g/day (for a 24-liter LPG cylinder at 20 bar pressure and at 50° C. temperature). Such a high rate of leakage is not acceptable from a design, regulation and consumer view point. A LPG composite vessel structure having a liner material other than the current HDPE liner that provides a LPG leak rate lower than the current HDPE liner would be advantageous to manufacturers of composite vessels containing HDPE liners.

Y. Lin and H. Yasuda, “Hydrocarbon Barrier Performance of Plasma-Surface-Modified Polyethylene”, Journal of Applied Polymer Science, Vol. 60, pp. 2227-2238 (1996) discloses providing an enhanced hexane barrier in HDPE by argon plasma polymerization of acrylic acid and acetylene. However, this reference teaches a less polar coating than is desirable in the manufacture of composite vessels.

### SUMMARY

One embodiment of the present invention is directed to a composite vessel structure including: (I) a shell comprising a housing wall with an inside wall surface and an outside wall surface; and (II) a barrier liner with an inner wall surface and an outer wall surface; wherein the outer wall surface of the barrier liner is juxtaposed to the inside wall surface of the housing wall; and wherein the barrier liner includes a multi-layer combination of (A) at least one polymeric substrate having a first and second surface; and (B) at least one gas barrier coating layer attached to at least a portion of at least one surface of the polymeric substrate.

Another embodiment of the present invention is directed to the above barrier liner useful in composite vessels wherein the barrier liner includes (A) at least one polymeric substrate layer having a first and second surface; and (B) at least one gas barrier coating layer attached to at least a portion of at least the first surface of the polymeric substrate.

In still another embodiment of the present invention, the above barrier liner useful in composite vessels includes (A) at least one polymeric substrate layer having a first and second surface; (B) at least one gas barrier coating layer attached to at least a portion of the first surface of the polymeric substrate; and (C) at least one gas barrier coating layer attached to at least a portion of the second surface of the polymeric substrate

Yet another embodiment of the present invention is directed to a composite vessel structure including: (I) a shell comprising a housing wall with an inside wall surface and an outside wall surface; (II) a barrier layer with an inner wall surface and an outer wall surface; and (III) a barrier liner with an inner wall surface and an outer wall surface; wherein the inner wall surface of the barrier layer is juxtaposed to the outer wall surface of the barrier liner; and wherein the outer wall surface of the barrier layer is juxtaposed to the inside wall surface of the housing wall.

Even still another embodiment of the present invention is directed to a composite vessel structure including: (I) a shell comprising a housing wall with an inside wall surface and an outside wall surface; (II) a first barrier layer with an inner wall surface and an outer wall surface; (III) a barrier liner with an inner wall surface and an outer wall surface; wherein the inner wall surface of the first barrier layer is juxtaposed to the outer wall surface of the barrier liner; and wherein the outer wall surface of the first barrier layer is juxtaposed to the inside wall surface of the housing wall; and (IV) a second barrier layer with an inner wall surface and an outer wall surface; wherein the outer wall surface of the second barrier layer is juxtaposed to the inner wall surface of the barrier liner; and wherein the inner wall surface of the second being in contact with the contents in the internal volume of the housing wall.

Even yet another embodiment of the present invention is directed to the above gas barrier coating layer useful in the above barrier liner, wherein the gas barrier coating layer includes a reaction product of: (a) a gas barrier active compound; and (b) at least one photoinitiator.

Another embodiment of the present invention is directed to an ultraviolet light (UV) curable composition for producing the above gas barrier coating layer, wherein the UV curable composition includes (a) a gas barrier active compound; and (b) at least one photoinitiator. Optional compounds that can be added to the UV curable composition may include for example (c) at least one silicone-containing surface additive; and (d) at least one photosensitizer.

Still another embodiment of the present invention is directed to a process for manufacturing the above composite vessel including the steps of: (i) forming a barrier liner; (ii) forming a shell comprising a housing wall with an inside and outside wall surface; and (iii) adhering said barrier liner to the inside wall surface of the housing wall of the vessel.

Yet another embodiment of the present invention is directed to a process for manufacturing the above barrier liner useful in composite vessels including the steps of: (A) providing a polymeric substrate; (B) providing a gas barrier coating layer; and (C) attaching the gas barrier coating layer to at least a portion of the polymeric substrate layer.

Still a further embodiment of the present invention is directed to a process for manufacturing the above gas barrier coating layer including the steps of: (I) providing a UV curable composition comprising a mixture of: (a) a gas barrier active compound; and (b) at least one photoinitiator; and (II) curing the UV curable mixture of step (I) above.

Yet a further embodiment of the present invention is directed to a process for preparing the above UV curable composition including admixing: (a) a gas barrier active compound; and (b) at least one photoinitiator.

One objective of the present invention is to provide a composite cylinder or vessel with a barrier liner, wherein the barrier liner is fabricated for example by forming a gas barrier coating layer such as an acrylic acid coating layer on at least a portion of a polymeric substrate layer such as a HDPE substrate layer such that the acrylic acid coating layer imparts a superior hydrocarbon or LPG barrier to the liner, and ultimately, to the composite cylinder as a whole.

Some of the advantages of using the barrier liner of the present invention include, for example, curing the curable composition that forms the barrier liner at a fast rate such as in less than about 10 seconds; providing a uniform thickness of barrier liner; and providing a surface covering film forming layer.

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings.

FIG. 1 is a cross sectional view of a composite cylindrical vessel showing various layers of the composite vessel of the present invention.

FIG. 2 is a cross sectional view taken along line 2-2 of FIG. 1.

FIG. 3 is a bar chart showing the leakage rate of methyl butane from an uncoated HDPE plate versus a coated HDPE plate of the present invention.

FIG. 4 is a flow chart showing a process of the present invention.

### DETAILED DESCRIPTION

One broad embodiment of the present invention includes a composite cylinder or vessel structure comprising (a) a composite shell comprising a housing wall with an inside wall surface and an outside wall surface; and (b) a multi-layer barrier liner attached to the inside wall surface of the composite shell.

Another broad embodiment of the present invention is directed to the above multi-layer barrier liner useful in composite cylinders and vessels; and more particularly, to a multi-layer barrier liner for use in composite cylinders and vessels such as composite vessels that are adapted to hold a fluid such as (1) liquefied petroleum gas (LPG) with composition of x % propane, y % butane, and wherein x+y≦100; (2) light hydrocarbons such as methane, ethane, ethylene, propylene and mixtures thereof; (3) aromatic compounds such as benzene, toluene, xylene and mixtures thereof; and (4) chlorohydrocarbons such as dichloroethane capable of permeating through the wall of a polymeric substrate layer material.

For example, in one preferred embodiment, the multi-layer barrier liner includes (a) at least one polymeric substrate layer such as HDPE; and (b) at least one coating layer such as an acrylic acid coating layer attached to or coated on at least a portion of the polymeric substrate layer such as for example on at least one side of the polymeric substrate layer.

“Vessel” herein means a closable container of any geometry like a cylinder or a pipe or a tank.

“Permeability” herein means volume of a permeate passing through a given thickness of a substrate per unit pressure differential per unit surface area of the substrate per unit time (cm3.cm/Torr/cm²/sec).

“Leak rate” herein means permeate loss in grams per day (g/day) for a given volume of a cylinder at a specified pressure and a specified temperature.

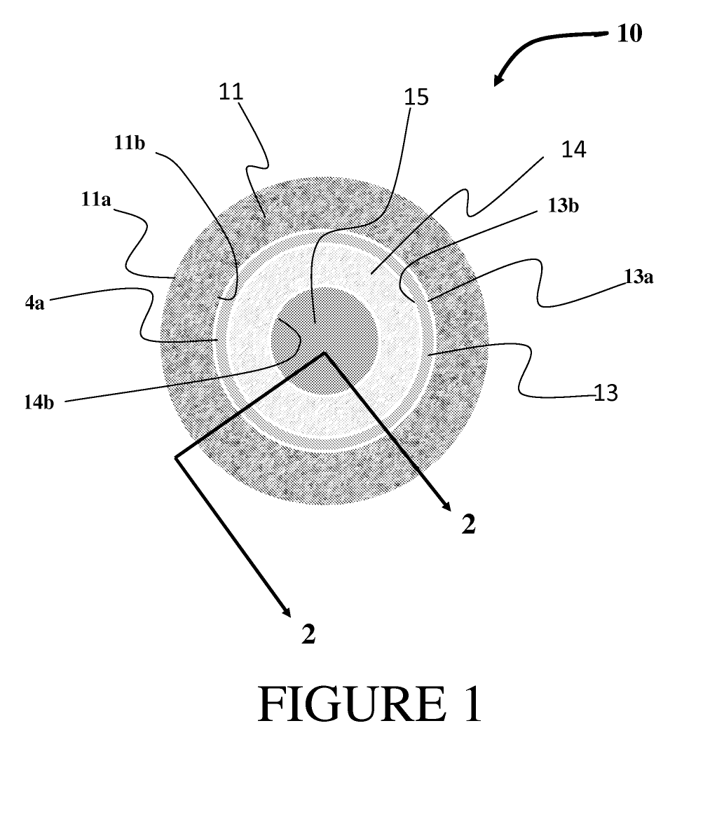

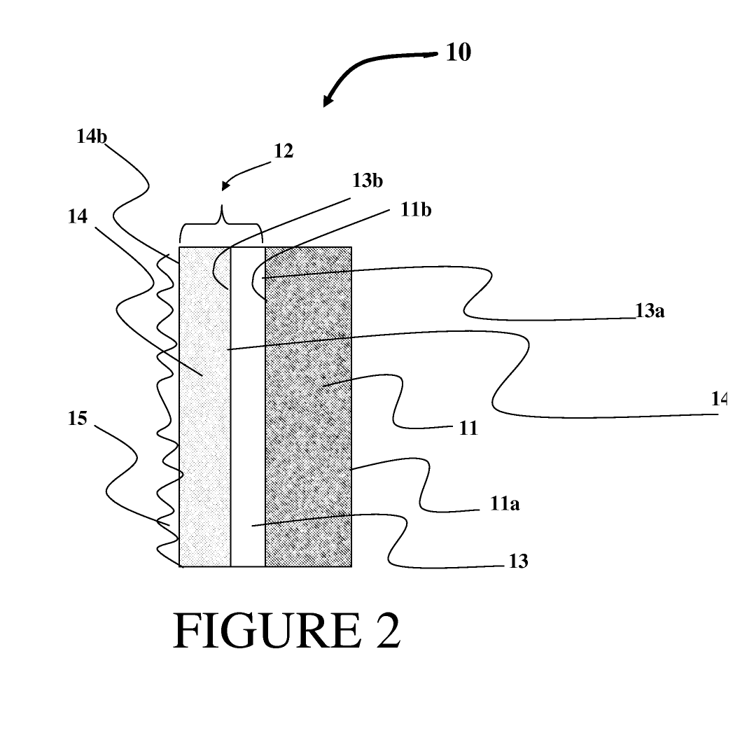

With reference to FIGS. 1 and 2, there is shown a composite vessel structure of the present invention, generally indicated by reference numeral 10. The vessel 10 includes a composite shell layer comprising a shell or housing wall 11 with an outside surface 11a and inside surface 11b. The vessel 10 also includes a barrier liner, generally indicated by reference numeral 12 in FIG. 2, wherein the barrier liner 12 comprises a coating layer 13 adhered to a polymeric substrate 14; and wherein one side 13a of the coating layer 13 is attached to the inside surface 11b of the housing wall 11 of the vessel 10; and the other side 13b is attached to one side 14a of the substrate 14. The other side 14b of the substrate 14, which is not coated with the coating layer 13, is in contact with a fluid 15 which is present and contained in the vessel 10.

With reference to FIG. 2, there is shown a portion of the composite vessel structure 10 taken along line 2-2. Also shown in FIG. 2 are layers 11-14 of the vessel 10 and a fluid 15 contained in the vessel 10. The fluid 15 is in contact with the surface 14b of the substrate 14.

The shell or housing wall 11 of the composite vessel 10 may be made of any thermoset material useful for structural integrity and for containing a fluid. For example, the housing wall 11 may be constructed of a thermoset such as epoxy resins, polyesters, vinyl esters, phenolics, polyurethanes, polydicyclopentadiene, and mixtures thereof.

In one preferred embodiment, the shell 11 is made of an epoxy resin material. For example, the epoxy resins which may be used in the present invention may be any epoxy resin or combination of two or more epoxy resins known in the art such as epoxy resins described in Lee, H. and Neville, K., Handbook of Epoxy Resins, McGraw-Hill Book Company, New York, 1967, Chapter 2, pages 2-1 to 2-27, incorporated herein by reference.

Suitable epoxy resins known in the art include for example epoxy resins based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known in the art include for example reaction products of epichlorohydrin with o-cresol novolacs, hydrocarbon novolacs, and, phenol novolacs. The epoxy resin may also be selected from commercially available products such as for example, D.E.R. 331®, D.E.R.332, D.E.R. 354, D.E.R. 580, D.E.N. 425, D.E.N. 431, D.E.N. 438, D.E.R. 736, or D.E.R. 732, epoxy resins available from The Dow Chemical Company.

In another embodiment, the shell or housing wall 11 of the composite vessel 10 may be made of a thermoset material with a reinforcement material. For example, the reinforcement material may be a fiber embedded in the composite thermoset matrix; and the fiber may be made from for example glass, carbon, aramid, and mixtures thereof.

In one embodiment, the composite cylinder/vessel structure of the present invention includes a wall structure (shell) of the vessel and a barrier liner adhered to the wall of the vessel. As shown in FIGS. 1 and 2, a barrier liner 12 is attached to the inside shell surface 11b. Generally, the barrier liner 12 comprises a coating layer 13 such as an acrylic coating layer bonded to a substrate layer 14 such as HDPE.

In one embodiment of the present invention, the barrier liner indicated by reference numeral 12 in FIGS. 1 and 2, useful in the composite vessels of the present invention includes a multi-layer system. The barrier liner includes at least one gas barrier coating layer 13 attached to at least a portion of at least one polymeric substrate layer 14 forming the barrier liner 12. Other layers of various materials can be included in the multi-layer barrier liner such as for example a layer of poly(vinylidene chloride), poly(ethylene-vinyl alcohol), poly(vinylidene fluoride), any halogenated polyethylene, or mixtures thereof.

The gas barrier coating layer useful in the above barrier liner includes a thermoset reaction product fabricated by curing a UV curable formulation or composition.

The UV curable composition of the present invention for producing the above gas barrier coating layer includes (a) a gas barrier active compound; and (b) at least one photoinitiator. Optional compounds that can be added to the UV curable composition may include for example (c) at least one silicone-containing surface additive; and/or (d) at least one photosensitizer.

In one embodiment, the gas bather active compound of the UV curable composition or formulation for making the gas bather coating layer may include for example at least one polar acrylic acid; at least one highly polar acrylate; styrene, derivatives of styrene; or mixtures thereof. One preferred embodiment, for example includes a polar acrylic acid or a polar acrylate as the gas barrier active compound.

The acrylic acid and the highly polar acrylate may be considered a film former additive included in the UV curable formulation for making the gas barrier coating layer of the present invention. The gas barrier active compound or film former may include any compound that can impart hydrocarbon bather for example polar acrylates such as 2-hydroxyl ethyl acrylate, 2-hydroxy ethyl methacrylate, methacrylic acid, itaconic acid, 2-acrylamido-2-methylpropane sulfonic acid (AMPS) or its salts, or mixtures thereof; or any one or more of the following compounds:

Monomers having from 1 to 20 carbon atoms such as, for example, methyl acrylate, methyl methacrylate, ethyl acrylate, ethyl methacrylate, propyl acrylate, propyl methacrylate, butyl acrylate, butyl methacrylate, hexyl acrylate, hexyl methacrylate, 2-ethyl hexyl acrylate, 2-ethyl hexyl methacrylate, isobornyl acrylate, isobornyl methacrylate; vinyl esters of carboxylic acids having in the range of from 1 to 20 carbon atoms, such as, for example, vinyl acetate, vinyl propionate, vinyl laurate, vinyl stearate; vinyl aromatics such as, for example, styrene, alpha-methyl styrene, 4-methyl styrene; vinyl ethers such as, for example, vinyl methyl ether, vinyl isobutyl ether; acrylonitrile; methacrylonitrile; acrylamide, methacrylamide; functionalized acrylic acid esters and functionalized methacrylic acid esters such as, for example, 2-hydroxyethyl acrylate, 2-hydroxy ethyl methacrylate, 2-hydroxy propyl acrylate, 2-hydroxy propyl methacrylate, 3-hydroxy propyl acrylate, 3-hydroxy propyl methacrylate, 4-hydroxy butyl acrylate, 4-hydroxyl butyl methacrylate; and any combination of the above compounds.

The concentration of the gas barrier active compound used in the present invention may range generally from 0.5 weight percent (wt %) to 99.9 wt % in one embodiment, from 10 wt % to 99.9 wt % in another embodiment, and from 50 wt % to 99.9 wt % in still another embodiment, based on the total weight of the composition. The efficacy of barrier improvements might suffer below the concentrations described above for this component.

In one preferred embodiment when the gas barrier active compound used in the present invention is at least one acrylic acid, the concentration of the at least one acrylic acid may range generally from 0.5 weight percent to 99.9 weight percent in one embodiment, from 0.5 wt % to 80 wt % in another embodiment, from 0.5 wt % to 50 wt % in still another embodiment, and from 0.5 wt % to 30 wt % in yet another embodiment, based on the total weight of the composition.

In another preferred embodiment when the gas bather active compound used in the present invention is at least one acrylate, the concentration of the at least one acrylate may range generally from 0.5 wt % to 80 wt % in one embodiment, from 0.5 wt % to 50 wt % in another embodiment, and from 0.5 wt % to 30 wt % in still another embodiment, based on the total weight of the composition. In still another embodiment, when the gas barrier active compound used in the present invention is at least one polar acrylate, the concentration of the at least one polar acrylate may range generally from 0.1 wt % to 50 wt %.

In one embodiment, the photoinitiator compound of the UV curable composition or formulation for making the gas bather coating layer may include for example diphenyl benzoyl phosphine oxide, and/or other photoinitiators which generate radicals and initiate photopolymerization. In another embodiment, for example, any one or more of the following compounds can also be used as the photoinitiator in the present invention including: acetophenone, anisoin, anthraquinone, anthraquinone-2-sulfonic acid sodium salt, (benzene) tricarbonyl chromium, benzyl, benzoin, benzoin ethyl ether, benzophenone, benzophenone/1-hydroxycyclohexyl phenylketone, 3.3′,4,4′-benzophenone-tetracarboxylic dianhydride, 4-benzoylbiphenyl, 2-benzyl-2-(dimethylamino)-4′morpholinobutyrophenone, 4,4′bis(diethylamino)benzophenone, 4,4′bis(dimethyl-amino)benzophenone, camphorquinone, 2-chlorothioanthen-9-one, (cumene)cyclo-pentadienyliron(II) hexafluorophosphate, dibenzosuberenone, 2,2′diethoxyacetophenone, 4,4′dihydroxybenzophenone, 2,2-dimethoxy-2-phenylacetophenone, 4-(dimethyl-amono)benzophenone, 4,4′dimethylbenzil, 2,5-dimethylbenzophenone, 3,4-dimethylbenzophenone, diphenyl (2,4,6trimethylbenzoyl)phosphine oxide/2-hydroxy-2-methylpropiophenone, 4′ethoxyacetophenone, 2-ethylanthraquinone, ferrocene, 3-hydroxyacetophenone, 4′-hydroxyacetopnenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methylbenzoylformate, 2-methyl-4′(methylthio)-2-morpholinopropio-phenone, phenylanthrenequinone, 4′-phenoxy acetophenone, thioanthene-9-one, triarylsulfonium hexafluoroantimoniate salts, triarylsulfonium hexafluorophosphate salts; or mixtures thereof.

The concentration of the at least one photoinitiator used in the present invention may range generally from 0.1 wt % to 5 wt % in one embodiment, from 0.1 wt % to 3 wt % in another embodiment, and from 0.1 wt % to 1 wt % in still another embodiment, based on the total weight of the composition. At concentrations of the photoinitiator of less than 0.1 wt %, the rate of photopolymerization is very slow and not practical from application view point. At concentrations of the photoinitiator of greater than 5 wt %, the composition undergoes an exotherm which causes smoking, yellowing and charring of film prepared from the composition.

The at least one photoinitiator useful in the present invention can be active between 200 nm and 400 nm

In one embodiment, the silicone-containing surface additive of the UV curable composition or formulation for making the gas barrier coating layer may include, for example but not limited to, polydimethylsiloxane polyethyleneoxide block copolymers, polydimethylsiloxane polypropyleneoxide polyethyleneoxide block copolymers, or mixtures thereof.

The concentration of the at least one silicone-containing surface additive used in the present invention may range generally from 0 wt % to 5 wt % in one embodiment, from 0.01 wt % to 5 wt % in another embodiment, from 0.01 wt % to 0.5 wt % in still another embodiment, and from 0.01 wt % to 0.1 wt % in yet another embodiment, based on the total weight of the composition. It is advantageous to use an additive, such as the silicone-containing surface additive, to assist in the film formation of the coating layer. Without the silicone-containing surface additive or at concentrations lower than 0.01 wt %, film formation on a HDPE surface is hampered. At concentrations greater than 5 wt %, no further practical benefit is observed.

In one embodiment, when a silicone-containing surface additive is not used in the composition, the addition of a non polar acrylate as aforementioned can rectify the benefit observed with a silicone-containing surface additive.

In another embodiment, a non silicone-containing surface additive of the UV curable composition or formulation for making the gas barrier coating layer may include for example surfactants of various kinds such as anionic, cationic, nonionic and amphoteric surfactants; and mixtures of two or more of such surfactants. As one embodiment and not to be limited thereby, examples of anionic, cationic, nonionic and amphoteric surfactants may be selected from alcohol ether sulfonates, linear alkyl benzene sulfonates, aceyl isethionate, alcohol sulfates, methyl ester sulfonates, aromatic sulfonates, naptha sulfonates, sulphosuccinates, alkyl diphenyloxide disulfonates, alcohol phosphates, fatty acid esters, nonylphenol ethoxylates, alkyl phenol ethoxylates, ethylene oxide-propylene oxide copolymers, fatty alkanol amides, alkyl polyglycosides, alkylamines, quartenary ammoniums and nitriles, fatty amine oxides, betaines or mixtures thereof.

The concentration of the non-silicone-containing surface additive used in the present invention may range generally from 0 wt % to 5 wt % in one embodiment, from 0.1 wt % to 3 wt % in another embodiment, and from 0.1 wt % to 1 wt % in still another embodiment, based on the total weight of the composition.

In one embodiment, the photosensitizer compound of the UV curable composition or formulation for making the gas bather coating layer may include for example xanthone, xanthone derivatives, or mixtures thereof.

The concentration of the at least one photosensitizer used in the present invention may range generally from 0 wt % to 5 wt % in one embodiment, from 0.01 wt % to 3 wt % in another embodiment, from 0.01 wt % to 2 wt % in still another embodiment, from 0.1 wt % to 3 wt % in yet another embodiment, and from 0.1 wt % to 1 wt % in even still another embodiment, based on the total weight of the composition.

The UV curable formulation for making the gas barrier layer of the present invention may include various optional additives for example crosslinkers such as ethylene glycol diacrylate, ethylene glycol dimethacrylate, divinyl benzene, or mixtures thereof; other film forming or film property (mechanical, tack, hardness, gloss) enhancing compounds such as acrylate or methacrylate monomers including for example styrene based monomers, external adhesive property enhancing monomers, and mixtures of two or more of the above optional additives.

In another embodiment, other optional compounds may include for example diacrylates (such as ethylene glycol diacrylate, diethylene glycol diacrylate, or mixtures thereof) or multifunctional acrylates which can act as crosslinkers in the formulation.

In still another embodiment, optional compounds that can be added to the composition include polymeric additives such as for example poly(vinylidenechloride), poly(ethylene-vinyl alcohol), poly(vinylidene fluoride), any halogenated polyethylene, or mixtures thereof. The compounds advantageously can dissolve the acrylates used or can be dispersed in the acrylate formulation; and thus can help in enhancing the barrier properties of the gas barrier layer of the present invention.

The process for preparing the UV curable composition includes the step of admixing: (a) a gas barrier active compound; and (b) at least one photoinitiator.

The preparation of the formulation of the present invention, and/or any of the steps thereof, may be a batch or a continuous process. The mixing equipment used in the process may be any vessel and ancillary equipment well known to those skilled in the art.

The process for manufacturing the gas barrier coating layer includes the steps of: (I) providing a UV curable composition comprising a mixture of: (a) a gas barrier active compound; and (b) at least one photoinitiator; and (II) curing the UV curable mixture of step (I) above.

The UV curable formulation may be cured with any well known UV source. For example a representative list of useful UV sources may include bactericidal lamps, black light lamps, carbon, xenon and other arcs, fluorescence equipment, hydrogen and deuterium lamps; metal halide lamps, mercury lamps, plasma torches, phototherapy lamps, printing ink polymerizing equipment, and welding equipment.

In one embodiment for example, the UV source useful in the present invention may be of 365 nm intensity and a 256 nm lower intensity can be used in the present invention such as a mercury arc lamp. The mercury arc lamp also provides a UV lamp intensity of from 0.01 mW/cm² to 500 mW/cm²; and a UV lamp emission wavelength of from 365 nm to 220 nm

The UV curable formulation may be cured using a thermal curing process, in another embodiment or the UV curable formulation may be cured using a pre-polymerized coating process in still another embodiment. Using the above thermal processes, it is well known in the art that thermal ageing of an acrylate formulation results in curing of the solution.

The gas barrier coating layer exhibits a few properties that are important in the end use application for composite vessels including for example, a barrier to permeation of the fluid contained in the vessel. Generally, the barrier property is measured by leakage rate; and the leakage rate may be from 2 g/day to 3 g/day of methyl butane through 2 mm thick composite disc with 47 mm diameter exposed to 2 atm pressure at 50° C. in one embodiment; and from 0.4 g/day to 0.6 g/day of methyl butane through 2 mm thick composite disc with 47 mm diameter exposed to 2 atm pressure at 50° C. in another embodiment.

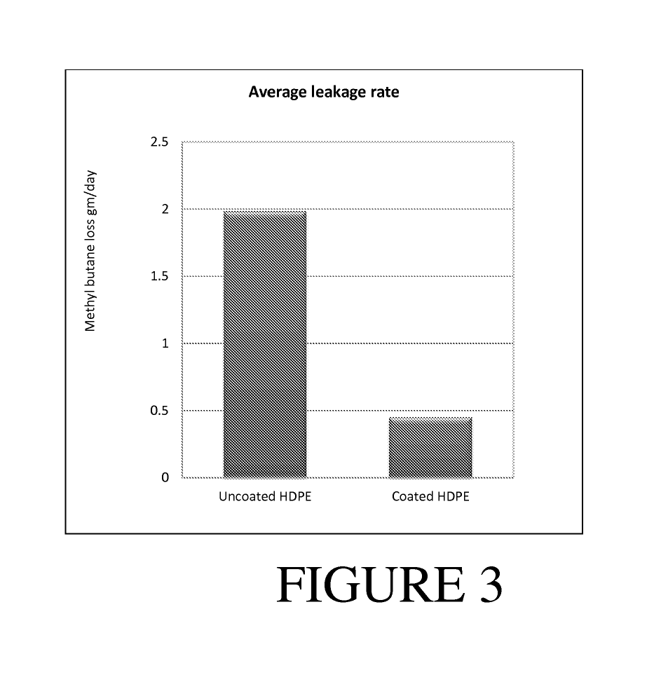

For example, with reference to FIG. 3, there is shown a bar chart comparing the leakage rate of methyl butane from an uncoated HDPE plate versus a coated HDPE plate of the present invention. The uncoated HDPE plate shown in FIG. 3 is 2 mm in thickness and 47 mm in diameter; and the coated HDPE plate of the present invention has the same dimensions and is coated with a barrier layer in accordance with the present invention. Both the uncoated HDPE plate and the coated HDPE plate are tested under the same testing conditions such as for example each plate is held at 50° C. and 2 bar pressure for a day (24 hours). The leakage rate of each plate is then measured in g/day.

Another property important for the gas barrier coating layer to exhibit for the end use application for composite vessels includes for example Tg. Generally, the Tg of the barrier coating layer is from 50° C. to 200° C. in one embodiment and from 70° C. to 120° C. in another embodiment.

The polymeric substrate layer may include all thermoplastics such as for example, polyethylene terephthalate (PET), polypropylene (PP), low density polyethylene (LDPE), linear low density polyethylene (LLDPE), polycarbonate (PC). polycarbonate-acrylonitrile butadiene-styrene blend (PC-ABS), high density polyethylene (HDPE) and a combination of two or more of the above polymeric substrates.

In one preferred embodiment, the polymeric substrate layer is HDPE which has been made by a blow molded process or any other known processes like compression molding, and injection molding.

In general, the process for manufacturing the barrier liner useful in composite vessels includes the steps of: (A) providing a polymeric substrate; (B) providing a gas barrier coating layer; and (C) attaching the gas barrier coating layer to at least a portion of the polymeric substrate layer.

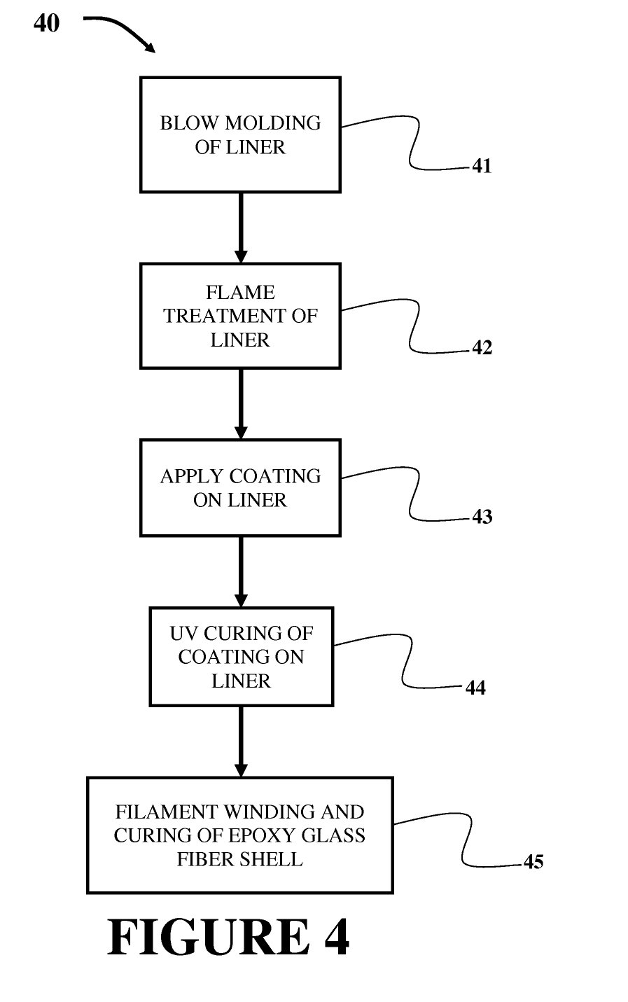

With reference to FIG. 4, there is shown a flowchart illustrating the overall process of preparing a composite vessel including the various steps of manufacturing the barrier liner of the present invention. As shown in FIG. 4, the process, generally indicated by numeral 40, includes the step 41 of first blow molding a HDPE substrate to provide a HDPE layer for the barrier liner. Then, in step 42 the HDPE substrate is treated prior to coating. For example, in one embodiment, the substrate layer to be coated with the UV curable formulation is HDPE substrate layer may be treated with a flame/corona/plasma treatment. The above treatment processes are described in Surface Modification and Functionalization of Polytetrafluoroethylene Films, E. T. Kang and K. L. Tan K. Kato, Y. Uyama, and Y. Ikada, Macromolecules 1996, 29, 6872-6879; Graft Polymerization of Acrylic Acid onto Polypropylene Monofilament by RF Plasma, Shalini Saxena, Alok R. Ray, Bhuvanesh Gupta, Journal of Applied Polymer Science, Vol. 116, 2884-2892 (2010); and U.S. Pat. No. 2,795,820; all which are incorporated herein by reference. In one preferred embodiment, the substrate is treated by flame treatment with a blue flame.

Then, in step 43, the gas barrier coating layer is applied to the HDPE substrate by a coating method such as (1) roller, (2) spray, (3) brush, (4) dip, or a combination thereof.

Once the coating layer is applied to the HDPE substrate, in step 44 the coating is cured on the substrate. Generally, the coating is UV cured using a UV source. At any one spot or portion of the coating the curing can be completed for example in 2 seconds to 10 seconds at room temperature operation.

In another optional embodiment, the coating may be preformed and then the coating can be applied or adhered to the substrate by known means.

After the coating is cured and a stiff liner with sufficient structural integrity is formed, an outer epoxy glass fiber shell is formed using a filament winding process and curing process as shown in step 45 of process 40 shown in FIG. 4.

In the present invention, an acrylic formulation is coated over the HDPE liner where the acrylic coating imparts superior hydrocarbon or LPG barrier to the liner and eventually to the composite cylinder. Diffusion of any gas trough a media is a function of solubility and permeability of the medium. From theory the skilled artisan understands that a polar layer will reduce diffusion of non polar molecules like hydrocarbons. The UV photopolymerized acrylic coating is primarily based on acrylic acid. A polymerized acrylic acid layer is expected to reduce LPG gas diffusion through the HDPE layer as acrylic acid polymer coating is much higher in polarity when compared to HDPE or to a cured epoxy matrix.

In the present invention, LPG permeation experiments unequivocally show that UV polymerized acrylic coating layer leads to improved LPG barrier compared to a HDPE layer. For example, an uncoated HDPE sheet of 47 mm diameter and 2 mm thickness passes 2.5-2.7 g of 2-methyl butane per day (24 hours) when kept at a pressure of 2 atmospheres (atm) of methyl butane at 50° C. With a UV coated acrylic acid, the coated HDPE disk of the same thickness passes 0.5-0.7 g of methyl-butane per day (24 h) under the same conditions.

UV polymerization is important as it has the ability to react the growing acrylic acid polymer chain to the HDPE surface, as low wavelength (high frequency) UV generates surface radicals on polyethylene backbone which can form carbon-carbon bonds with an acrylate radical. The grafting can lead to superior adhesion which in turn can be better for barrier performance as the two layers will be chemically tied to each other leading to a better interface.

The process for manufacturing the composite vessel includes the steps of: (i) forming a barrier liner; (ii) forming a shell comprising a housing wall with an inside and outside wall surface; and (iii) adhering said barrier liner to the inside wall surface of the housing wall of the vessel.

Again with reference to FIG. 4, there is shown the overall process of preparing a composite vessel including the various steps of preparing the vessel itself. For example, after the coating is cured and a stiff liner with sufficient structural integrity is formed, an outer epoxy glass fiber shell is formed using a filament winding process and curing process. Other methods of shell making could be hand layup, spray layup, auto-clave molding, resin transfer molding, and vacuum assisted resin transfer molding.

The final composite vessel may be any size and volume. As one illustrative embodiment for example, a cylinder useful in the present invention may have a volume of from 5 mL to 20,000 liters of cylinder volume. And depending on the shape and size of the vessel, such as pipes, large storage tanks, other volumes may be used.

The composite system of the present invention may be used to prepare a composite container, cylinder or vessel; and the composite vessel may house or contain various fluids including for example LPG, methane, ethane, propylene, propane, butane, light hydrocarbons, pentane, hexane, gasolines, aromatics, chloro-hydrocarbons and mixtures thereof.

### EXAMPLES

The following examples and comparative examples further illustrate the present invention in detail but are not to be construed to limit the scope thereof.

Standard analytical equipment and methods were used to test the performance of the composite discs prepared in the Examples. For instance, the following general procedure was carried out on the composite discs described in the Examples:

General Procedure for Use of a Vessel

50 grams (g) of methyl butane is introduced into a pressure vessel container and the container is weighed. The container is sealed and temperature is maintained at 50 degrees centigrade (° C.) for 24 hours (hr). The initial amount and temperature of this system in this procedure is ensured such that methyl butane vapors are in continuous contact with a substrate. The container is cooled to room temperature (about 25° C.) to ensure complete condensation of methyl butane vapors in the headspace of the container. The weight of the container is recorded at the end of this procedure and the loss in weight corresponds to the methyl butane permeation through the substrate. This loss is further corrected for the weight loss due to leakage and venting.

### Examples 1-4

In Examples 1-4, 5 g of acrylic acid, 5 milligrams (mg) of BYK333, and 150 mg of trimethylbenzoyl diphenyl phosphine oxide were mixed in a beaker to form a curable coating formulation. BYK333 is a silicone based surfactant formulation commercially available from BYK.

The resulting formulation from the above mixture was brush coated on a flame treated high density polyethylene (HDPE) disc of 2 millimeters (mm) thickness and 47 mm diameter. The coated disc was placed under an ultraviolet (UV) lamp; and the formulation coated on the disc cured in 10 seconds (s) to 15 s. The resulting cured coated disc (“barrier liner”) was kept under the UV lamp for an additional 2 minutes (min) to achieve full reaction. The UV lamp used in Examples 1-4 was a mercury arc whose primary emission is at 365 nanometers (nm). The UV lamp had an intensity of 21 mW/cm² at a distance of 25 mm to 30 mm.

The General Procedure described above was used to test the cured coated disc in a pressure vessel container. The cured coated disc was placed in a flange and exposed to an auto-generated pressure of 2 atmospheres (atms) of methyl butane at 50° C. for 24 hr. The initial weight of the container was recorded. The pressure in the container was maintained by maintaining the temperature of 50° C. After 24 hr, the container was weighed to estimate the loss of methyl-butane material. The amount of methyl butane that permeated through the coated disc was in a range of from 0.3 g/day to 0.6 g/day. The results of Examples 1-4 are described in Table I.

### Comparative Examples A-C

The same procedure described in Examples 1-4 above was carried out except that HDPE discs (Comparative Examples A-C) were not coated with the coating formulations described in Examples 1-4. The non-coated discs exhibited a loss of from 1.9 g/day to 2.05 g/day of methyl-butane. The results of Comparative Examples A-C are described in Table I.

TABLE 1
Loss of Methyl Butane by Permeation

| | | Pressure | | | | Average | |
|---|---|---|---|---|---|---|---|
| | | difference | Temperature | Time | Loss | loss | Standard |
| Examples | | (psi) | (° C.) | (hr) | (g) | (g/day) | deviation |
| Coated | Ex. 1 | 14 | 50 | 24 | 0.3 | 0.45 | 0.129 |
| HDPE | Ex. 2 | 14 | 50 | 24 | 0.5 | | |
| | Ex. 3 | 14 | 50 | 24 | 0.4 | | |
| | Ex. 4 | 14 | 50 | 24 | 0.6 | | |
| Uncoated | Comp. Ex. A | 14 | 50 | 24 | 1.9 | 1.98 | 0.076 |
| HDPE | Comp. Ex. B | 14 | 50 | 24 | 2 | | |
| | Comp. Ex. C | 14 | 50 | 24 | 2.05 | | |

1. A barrier liner for a composite vessel comprising: (A) at least one polymeric substrate layer having a first and second surface; and (B) at least one gas barrier coating layer attached to at least a portion of at least the first surface of the polymeric substrate.

2. The barrier liner of claim 1 including (C) at least one gas barrier coating layer attached to at least a portion of the second surface of the polymeric substrate, and wherein the polymeric substrate is a high density polyethylene substrate.

3. (canceled)

4. A composite vessel structure comprising:
(I) a shell comprising a housing wall with an inside wall surface and an outside wall surface; and
(II) a barrier liner with an inner wall surface and an outer wall surface; wherein the outer wall surface of the barrier liner is juxtaposed to the inside wall surface of the housing wall; and wherein the barrier liner is the barrier liner of claim 1.

5. The composite vessel structure of claim 4, including further (III) a first barrier layer with an inner wall surface and an outer wall surface; wherein the inner wall surface of the first barrier layer is juxtaposed to the outer wall surface of the barrier liner; and wherein the outer wall surface of the first barrier layer is juxtaposed to the inside wall surface of the housing wall.

6. The composite vessel structure of claim 5, including further
(IV) a second barrier layer with an inner wall surface and an outer wall surface; wherein the outer wall surface of the second barrier layer is juxtaposed to the inner wall surface of the barrier liner; and wherein the inner wall surface of the second barrier layer is in contact with the contents in the internal volume of the housing wall.

7. A gas barrier coating layer for a barrier liner comprising a reaction product of: (a) at least one gas barrier active compound; and (b) at least one photoinitiator.

8. An ultraviolet light curable composition for a gas barrier coating layer, the curable composition comprising a mixture of: (a) at least one gas barrier active compound; and (b) at least one photoinitiator.

9. The curable composition of claim 8, including further
(c) at least one silicone-containing surface additive, wherein the at least one silicone-containing surface additive is an anionic surfactant, a cationic surfactant, a nonionic surfactant, an amphoteric surfactant, or mixtures thereof;
(d) at least one photosensitizer, wherein the at least one photosensitizer is a xanthone, a derivative of xanthone, or mixtures thereof;
(e) a combination of components (c) and (d); or
(f) at least one crosslinker, wherein the crosslinker is a diacrylate, a multifunctional acrylate, or mixtures thereof.

10-13. (canceled)

14. A process for manufacturing a composite vessel with a barrier liner comprising the steps of: (i) forming a barrier liner; wherein the barrier liner is the barrier liner of claim 1; (ii) forming a shell comprising a housing wall with an inside and outside wall surface; and (iii) adhering said barrier liner to the inside wall surface of the housing wall of the vessel.

15. (canceled)

16. A process for manufacturing a barrier liner comprising the steps of:
(I) providing a UV curable composition; wherein the UV curable composition is the curable composition of claim 8;
(II) coating a high density polyethylene substrate with the UV curable composition of step (I); and
(III) curing the coated high density polyethylene substrate of step (II) to form a barrier layer on the high density polyethylene substrate.

17. The process of claim 16, wherein prior to step (II), including the step of flame treating the surface of the high density polyethylene; or including the step of corona treating the surface of the high density polyethylene.

18. A process for manufacturing a gas barrier coating layer comprising the steps of:
(I) providing a UV curable composition; wherein the UV curable composition is the curable composition of claim 8; and
(II) curing the UV curable mixture of step (I) above.

19. (canceled)

20. (canceled)

21. The process of claim 8, wherein the gas barrier active compound is (a) acrylic acid; (b) at least one acrylate; (c) optionally, at least one silicone-containing surface additive; (d) optionally, at least one photosensitizer; or (e) mixtures thereof.

22. The process of claim 16, wherein the UV curable composition in Step (I) includes further (C) at least one surface additive; (D) at least one photoinitiator; (E) at least one photosensitizer; (F) a crosslinker; or (G) a mixture thereof.
